(19) United States
(12) Patent Application Publication
(10) Pub. No.: US 2004/0011932 A1
(43) Pub. Date: Jan. 22, 2004

(54) Stand for flat panel display

(76) Inventor: Simon Duff, Berowra Waters (AU)

Correspondence Address: Edwin D. Schindler, Five Hirsch Avenue, P.O. Box 966, Coram, NY, 11727-0966, US

(21) Appl. No.: 10/452,350

(22) Filed: Jun. 2, 2003

(30) Foreign Application Priority Data
Jun. 7, 2002 (AU) PS 2852

(51) Int. Cl. F16M 11/00

(52) U.S. Cl. 248/157; 248/274.1; 248/919; 361/681

(57) ABSTRACT

A stand 10 has a base 20 with upstanding portion 20 stationary therewith. The base 20 can rotate. A post 30 is attached to upstanding portion 20 by carriage 38 and knob 26. When knob 26 is in an unlocked position the carriage 38 slides in channel 44 of post 30. When knob 26 is in a locked position the post 30 remains stationary with respect to upstanding means 22. Carriage 38 is connected to post 30 by a constant force arrangement which can include coil spring(s), elastic cord(s) or a gas spring to provide balanced damped movement of post 30 when knob 26 is unlocked. At top end of post 30, a fixture 34, pivotable on adjustable pivot bolt 35, can hold a flat panel display on arms 99. Fixture 34 can be flipped over to provide a 15-20 mm height adjustment.

### FIELD OF THE INVENTION

The present invention relates to a stand for a flat panel display and in particular to a free standing stand for a plasma display, an LCD display or a TFT display.

### BACKGROUND OF THE INVENTION

With the decreasing price of many flat panel displays employing plasma technology or liquid crystal displays or other electronic techniques such as employed in TFT displays there is an increasing need for desk top or portable stands for locating these flat panel displays ergonomically in a working or a home environment. Prior art stands normally provide restricted rotational movement of the display with respect to the foot of the stand but do not provide extensive height adjustment of a display, for example to accommodate a variety of users or to accommodate a variety of sizes of panel displays using the one stand.

### SUMMARY OF THE INVENTION

The present invention seeks to overcome disadvantages in the prior art, or to ameliorate such disadvantages, or to provide an alternative thereto.

According to the invention there is provided a stand including a base for supporting said stand in an upright position on a substantially horizontal support surface; upstanding means extending upwardly from said base and stationary with respect thereto for supporting upwardly extending post means at a position elevated above said base; said post means being continuously movable with respect to said upstanding means from a first position to a second position; means for releasably securing said post means at a position from said first to said second position; attachment means for removably attaching a flat panel display device to an end of said post means.

Preferably, said base can also be rotated with respect to said support surface through up to 360° while said post means can be moved up to approximately 130 mm with respect to said upstanding means.

Preferably, said attachment means is located at an upper end of said post means and can be rotated through approximately 90° with respect to an axis substantially orthogonal with respect to the longitudinal axis of said post means. Preferably, said attachment means has two orientations allowing a height adjustment of approximately 20 mm in addition to the height adjustment provided by movement of said post means.

Preferably, the longitudinal axis of said post means is inclined forwardly approximately 7° with respect to the vertical, that is, the normal to the plane of the base, to ensure that the centre of gravity of the stand, with or without the flat panel display device attached, is located through the central area of the base of the stand to provide stability thereof irrespective of the position of the post means with respect to the upstanding means.

Preferably, said post means includes a first channel means and a second channel means, said first channel means providing a conduit for electrical leads to power said flat panel display device and said second channel means providing a guide path for a mechanism by which said post means may be moved and thereby adjusted in height, with respect to said base.

Preferably, said second channel means includes an open channel and said mechanism includes a carriage which may be releasably engaged by brake means whereby in a released condition of said brake means said second channel means can move with respect to said carriage and in an engaged condition of said brake means said second channel means is prevented from moving with respect to said carriage.

Alternatively, said second channel means includes an open channel and said mechanism includes a carriage which may be releasably engaged with said second channel means whereby in said released condition said channel can move with respect to said carriage and in said engaged condition said second channel means is engaged frictionally with said carriage thereby preventing movement of said second channel means with respect to said carriage. The first channel means may be an open or a closed channel.

Preferably, said carriage means further includes resilient means biasing said post means along said longitudinal axis. The resilient means may include one or two constant force springs. The constant force springs may be coil springs accommodated in said carriage means and having a free end thereof attached to an end of said post means.

### BRIEF DESCRIPTION OF THE DRAWINGS

Preferred embodiments of the invention will now be described with respect to the following figures in which:

FIG. 1 shows an assembled view of the stand according to the invention;

FIG. 2 shows an exploded schematic view of the stand of FIG. 1;

FIG. 3 shows detail of the upper end cap of the post of FIG. 1;

FIG. 4 shows detail of the carriage and lower end cap of the post of FIG. 1;

FIG. 5 shows detail of the carriage brake of the stand of FIG. 1.

FIG. 6 shows a second embodiment of a carriage;

FIG. 7 shows further detail of the arrangement of FIG. 6;

FIG. 8 shows an alternative embodiment for the base of the stand;

FIG. 9 shows an alternative embodiment for the carriage and base of the stand;

FIG. 10 shows a side view of the alternative embodiment of FIG. 9; and

FIGS. 11-20 show an alternative embodiment for the stand according to the invention.

### PREFERRED MODES FOR PERFORMING THE INVENTION

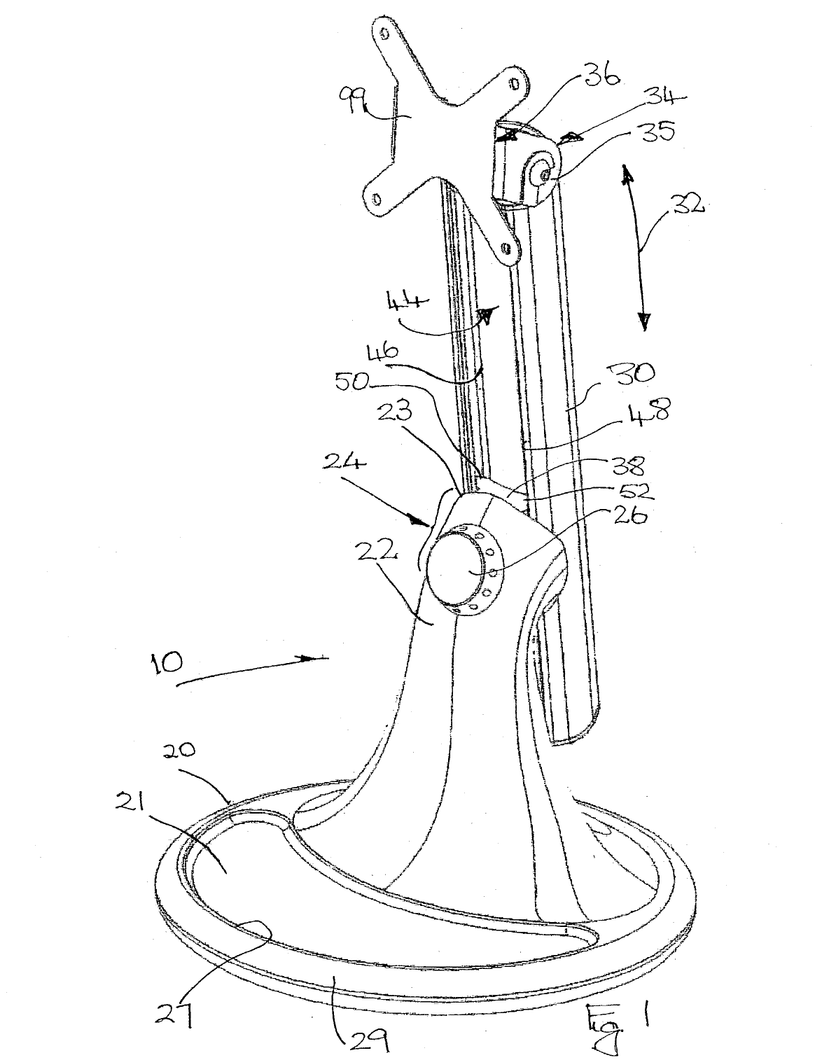

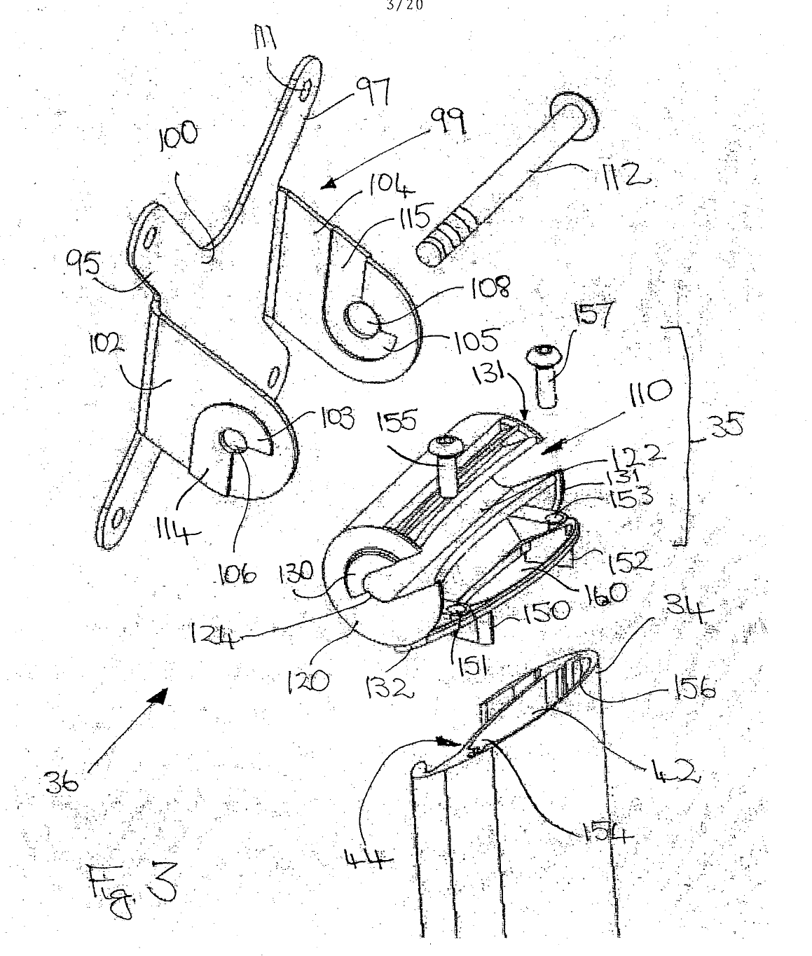

Referring to FIG. 1, the stand 10 includes a discoid base 20 with an upstanding portion 22 extending from near the centre towards the perimeter 29 thereof. The discoid base 20 has a recessed area or tray 21 in the front of the upstanding portion 22 for storing stationary and a lip 27 at the perimeter 29 thereof for supporting a keyboard between the perimeter 29 and the upstanding portion 22. A post portion 30 is connected to the upright portion 22 of the base 20 by a mechanism 24 including a carriage 38 and a knob 26. The mechanism 24 is attached to the upright portion 22 near the free end 23 thereof. The post portion 30 is moveable vertically with respect to said upstanding portion 22 as indicated by the double headed arrows 32. The post portion 30 has at its upper end 34 a support 36 for attaching a flat panel display device (not shown). The support 36 includes support bracket 99 which is removably attachable to a pivot 35. The pivot 35 allows the support bracket 99 to rotate through approximately 90 degrees as will be described with respect to FIG. 3.

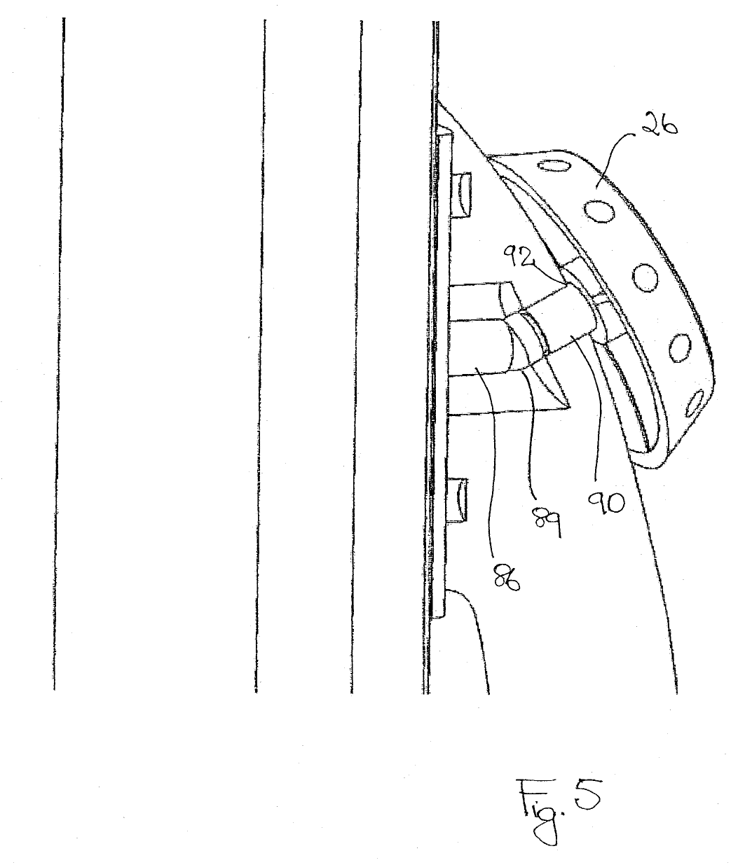

The post portion 30 slides on the carriage 38 which is fixed to the upright portion 22 of the base 20 while the knob 26 is connected, through the upright portion 22 of the base 20, to the carriage 38. The knob 26 is connected to the carriage 38 in a manner that will be described in more detail below with respect to FIG. 5. Rotation of the knob 26 clockwise causes the carriage 38 to be frictionally locked to the post 30 preventing movement of the post 30 with respect to the upright portion 22 of the base 20. Conversely, rotation of the knob 26 anti-clockwise causes the carriage 38 to be unlocked from frictional contact with the post 30 thereby allowing movement of the post 30 with respect to the upright portion 22 of the base 20.

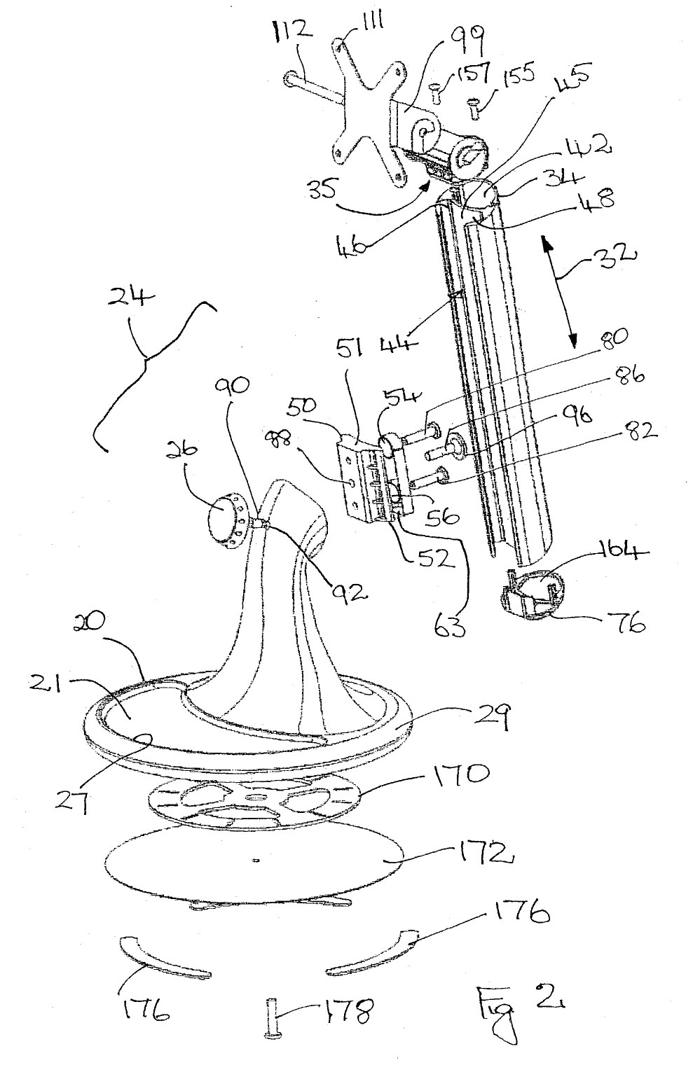

As shown in FIG. 2, the post 30, which may be made as an aluminium extrusion, has an enclosed channel 42 and an open channel 44. The open channel 44 is formed by the covering 45 of the closed channel 42 and grooved side walls 46, 48. The side walls 46, 48 accommodate respectively complementarily shaped runners or fins 50, 52 of the carriage 38.

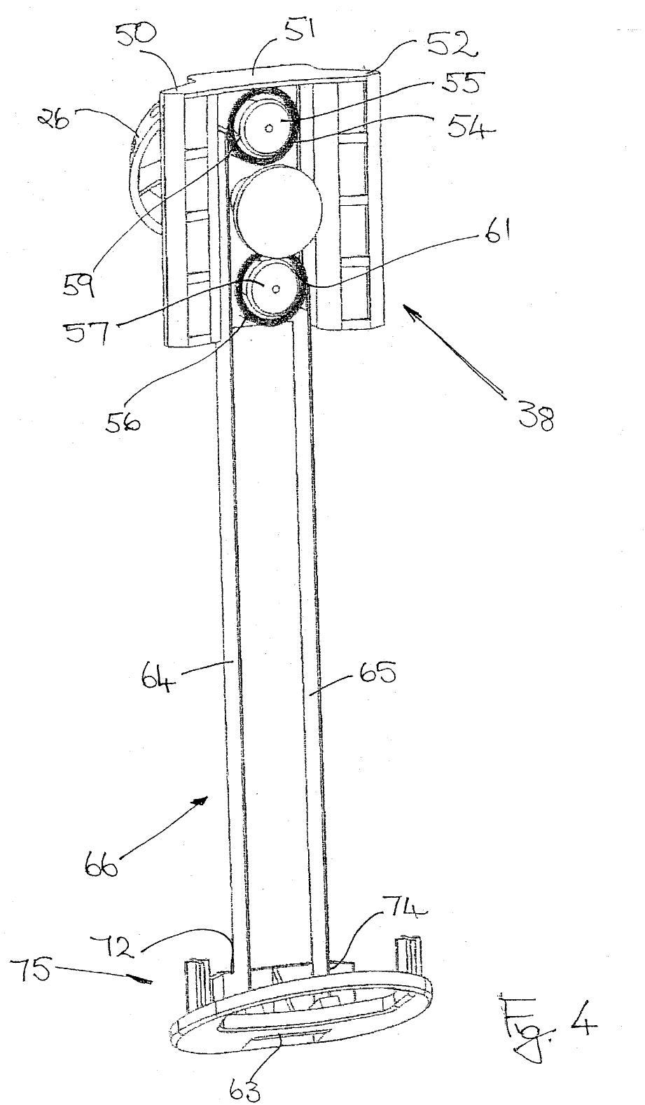

Referring to FIG. 4, the carriage 38 includes a central body 51 and a pair of outwardly projecting runners or fins 50, 52 shaped to fit and freely run in the side walls 46, 48 of the open channel 44 of the post 30. Two constant force springs 54, 56 are accommodated within the central body 51 of the carriage 38 wound on respective bosses 55, 57. The wound springs 54, 56 turn on rings 59, 61 fixed to their respective bosses 55, 57 and each spring 54, 56 is attached, for example by pressing, to an arm 64, 65 of a U-or a J-shaped pull 66. The arms 64, 65 of the pull 66 are of dissimilar length in order to join the respective arm 64, 65 to the respective outer diameters of each spring 54, 56 in the central body 31 of the carriage 38 when the pull 66 is in its retracted position as shown in FIG. 2. The base 63 of the U or J of the pull 66 is anchored in slots 68, 70 in elements 72, 74 of the lower end cover 76 of the post 30 with the cross-arm of the base 63 of the U or J shown in situ in FIG. 4. During assembly, the pull 66 is inserted into the slotted elements 72, 74 in the direction of arrow 75.

As shown in the assembled version of FIG. 1, the fins 50, 52 of carriage 38 rest in the grooves 46, 48 of the open channel 44 while, as shown in the exploded view of FIG. 2, the pins 80, 82 hold the carriage 38 to the upright portion 22 and act as the bosses 55, 57 for the springs 54, 56. A further pin 86 is positioned through a third hole 88 in the central body 51 of the carriage 38 and is used as a brake against the covering 45 of the closed channel 42. The brake 86 is operated by the knob 26 as shown in FIG. 5. The knob 26 is provided with a screw threaded axle 90 and is located in an aperture 92 of the moulding of the upright portion 22. Rotation of the knob clockwise advances the axle 90 towards the open channel 44. Rotation of the knob anti-clockwise withdraws the axle 90 away from the open channel 44. The axle 90 links to the brake 86 via a ball and socket type linkage 89 in order to compensate for the angle that the axle 90 makes with the longitudinal axis of the brake 86 in the embodiment shown. Other arrangements are contemplated within the knowledge of a person skilled in the art, including the axle 90 being co-axial with the longitudinal axis of the pin 86, the current arrangement being a matter of design resulting from the curved appearance of the upstanding portion 22, rather than being of a matter of the substance of the invention.

The brake 86 has a face 96 which can be flat or curved so as to contact the covering 45 of the closed channel 42 or, alternatively put, the base of the open channel 44. Releasing the brake 86 from contact with the covering 45 allows the post 30 to be moved manually upwardly or downwardly sliding on the fins 50, 52. When the post 30 has been adjusted to the required height the knob 26 is turned in a clockwise sense so as to tighten the brake 86 onto the covering 45 and to thereby frictionally lock the carriage 38 and the post 30 together.

As the post 30 moves upwardly or downwardly the pull 66 being anchored in the lower end cover 76 causes the constant force springs 54, 56 to unwind or wind up respectively. As the springs 54, 56 provide a constant force throughout the movement of the post 30 the effort involved in moving the post 30 between the extremities of its available movement is substantially the same. Moreover, the force applied by the springs 54, 56 is preferably designed to balance any force component along the longitudinal axis of the post due to the combined weight of the post 30, the support 36 and the attached flat panel display device, or due to friction whereby the post 30 does not have a tendency to either rise or fall as the post 30 is moved into a desired position relative to the carriage 38. Once the post 30 has been positioned as desired the knob 26 is rotated clockwise whereby the axle 90 drives the brake 86 forward until the face 96 contacts the covering 45.

The lower end cover 76 has a flange or an extension which acts as a stop so that the post 30 stops against the lower edge of the carriage 38 and does not extend beyond its upper limits.

In order that the stand 10 is stable throughout the range of movement of the post 30 the longitudinal axis of the post 30 is inclined forwardly at an angle of approximately 7° with respect to the vertical. In this way, a flat panel display device of 14″, 15″, or 17″ of weight 3-8 kg can be readily accommodated. This forward inclination of the longitudinal axis of the post 30 also provides additional braking of the carriage 38 by the fins 50, 52 of carriage 38 being skewed by the brake 86 with respect to the grooves 46, 48 of the open channel 44.

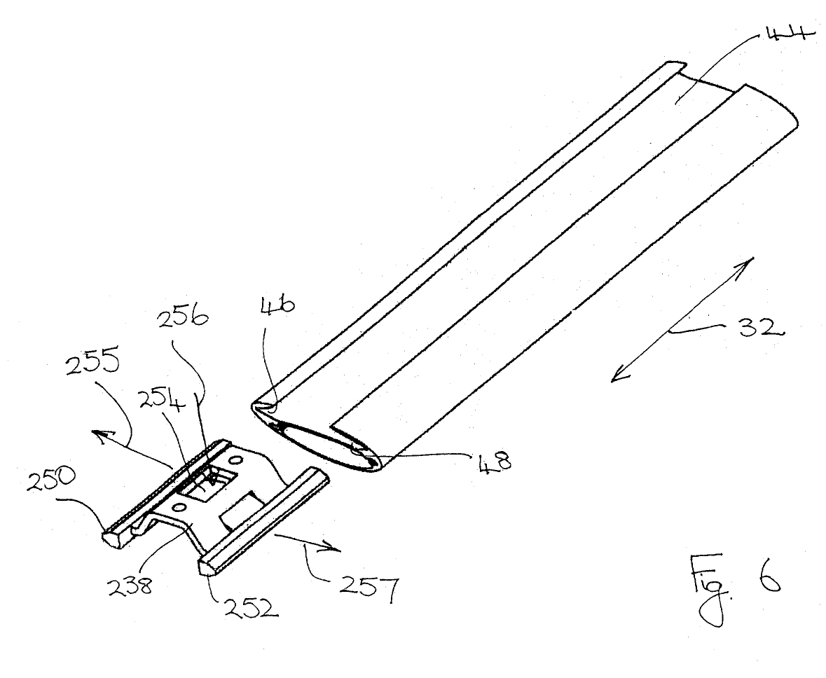

Other arrangements for controlling the movement of the post 30 with respect to the carriage 38 are contemplated and one further example will be described below with respect to FIG. 6.

As stated above, a flat panel display device is fixed to the support 36, which includes support bracket 99 and pivot 35. As shown more clearly in FIG. 3, the support bracket 99 comprises an X-shaped base 100 with rearwardly extending flanges 102, 104. Suitable fixtures, including screws or nuts, fix a flat panel display device to the support bracket 99 through the apertures 111 at the ends of the arms 95, 97 of the X-shaped support bracket 99. The apertures 111 are situated on 75 mm hole centres. It is further contemplated that the apertures 111 can be situated on 100 mm hole centres, to comply with the “VESA” standard, by fitting extension clips (not shown) over the X-shaped arms 95, 97 of the base 100. The flanges 102, 104 allow the support bracket 99 to be fixed to the C-shaped pivot body 110. The flanges 102, 104 have aligned apertures 106, 108 for accommodating a screw threaded bolt 112 and self clinching nut (not shown). The apertures 106, 108 are surrounded by a portion 114, 115 proud of or forming a channel raised with respect to the plane of the respective flange 102, 104. The proud portions 114, 115 of the respective flanges 102, 104 are inverted with respect to one another whereby the support bracket 99 can be fixed in two separate orientations and still mated to the pivot body 110. The pivot body 110 has at the face 120 a raised approximately semi-circular annulus 130 upon which the curved raised portion 103 of the flange 102, in the view shown, in FIG. 3, rests and pivots.

As shown in FIGS. 1 and 2, the support bracket 99 can be positioned in an upwardly inclined orientation of the flanges 102, 104. When the support bracket 99 is inverted or flipped over, the flanges 102, 104 point downwardly, with the flange 104 then being on the face 120 of the pivot body 110. In this way, the support bracket 99 allows a further adjustment in the height of the flat panel display device of approximately 15-20 mm.

In assembling the flat panel display device to the stand 10, the back of the panel is fixed to the support 36 with the bolt 1 12 in place through the apertures 106, 108. The bolt 112 is then slid through the opening 122 of the pivot body 110 to rest away from the edge 124 with the proud portions 103, 105 of the flanges 102, 104 supported on respective semi-circular annulus 130, 131 (131 not being visible in the view of FIG. 3). In this way, the bolt 112 sits clear of the pivot body 110 so as not to unwind or loosen with the continual movement of the support bracket 99 and attached display device. The bolt 112 is adjusted to ensure that the support bracket 99 is firmly held by the pivot body 110 so that the support bracket 99 can then be rotated to a desired position and retained in that position without further adjustment due to the frictional engagement or loading between the pivot body 110 and the support bracket 99. In the arrangement shown, the pivot body 110 allows the support bracket 99 to be rotated through approximately 90° with respect to the axis of the pivot bolt 112.

At the base 132 of the pivot body 110 an arrangement for mating the pivot body 110 to the post 30 includes a pair of supporting feet 150, 152 which are shaped to fit into complimentary shaped recesses 154, 156 of the closed channel 42. The mating arrangement includes an aperture 160 through which cables (not shown) from the back of the flat panel display device enter the closed channel 42. The cabling descends along the closed channel 42 and exits through the lower end cover 76 through aperture 164. The feet 150, 152 are provided with apertures 151, 153 for accommodating self tapping screws 155, 157 to secure the pivot body 110 to the upper end 34 of the post 30.

The post 30 can be moved through approximately 130 mm of linear travel. That is, for a post 30 of 280 mm length the maximum height to which the stand 10 can be raised is approximately 450 mm above the base 20 measured at the ends of the X-shaped arms 95, 97 of the support bracket 99. The minimum height of the stand is 320 mm measured in like manner. The above example is illustrative only and the maximum and the minimum heights of travel for the stand can be adjusted by providing a post 30 of greater or lesser length as required.

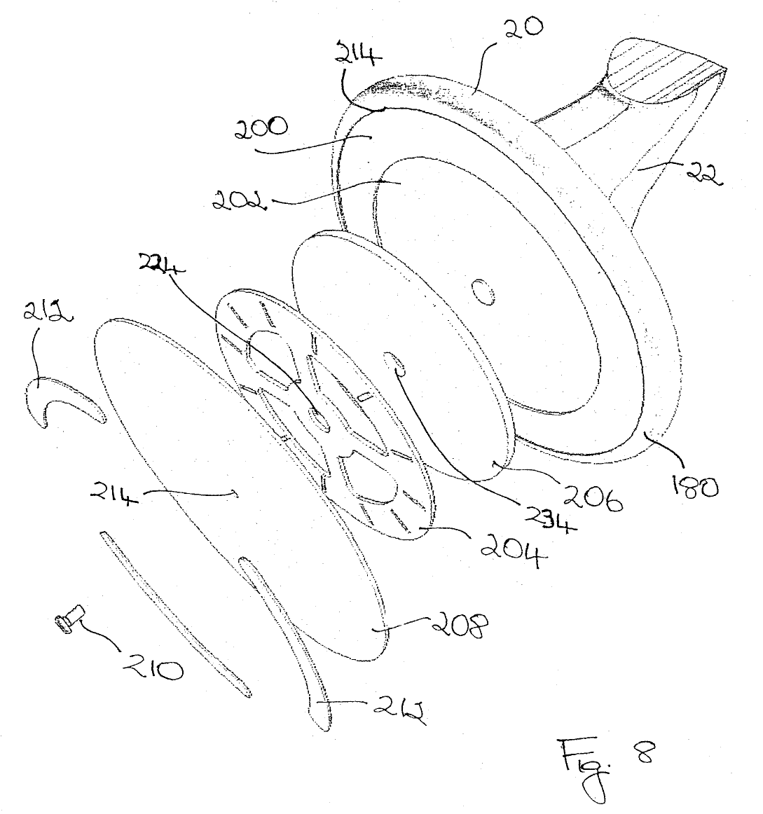

In addition, as shown in FIG. 2, the base 20 of the stand 10 can rotate with respect to the support surface upon which the stand 10 rests. The pivoting mechanism can be implemented in a number of embodiments but, as shown in FIG. 2, it includes a bearing element 170 and a covering plate 172 with both elements 170, 172 held in place by three banana shaped circlip elements 176 and a rivet or a screw threaded connection 178. The latter provides sufficient play between the bearing 170 and the covering plate 172 to allow one to rotate with respect to the other. The bearing 170 is preferably made of a plastics material such as acetal whereas the covering plate 172 is preferably made of metal. In the inside of the perimeter 180 of the base 20 a groove (see FIG. 8) is provided in order to allow the circlips 176 to be clipped in place to retain the covering plate 172 in position.

It is also contemplated that a sandwich of three elements may be used including an upper metal plate of similar diameter to that of the bearing as shown in FIG. 8 or Figure.

FIG. 8 shows an underneath view of the base portion 20 and an alternative mechanism allowing the base portion 20 to be rotatable. Base portion 20 includes a housing 200 having a recess 202 in which bearing 204 and bearing back plate 206 are accommodated. The bearing 204 is made of a low friction material. A stationary base support disc 208 holds the bearing 204 and back plate 206 in the recess 202 of the base portion 20 with a screw 210 through the centres 214, 224, 234 of the respective components 208, 204, 206 and circlips 212 around the perimeter 216 of the base portion housing 200. A lip 214 in the perimeter 216 of the base portion housing 200 accommodates the circlips 212 in a snap-in manner. The friction between the bearing elements can be adjusted by the construction of or, alternatively, the torque applied to the screw 210.

It is also contemplated that a single metal plate may be used in place of either two or three component parts for the mechanism providing a rotatable base by the use of a suitable fixture means providing the necessary spacing to allow free and stable rotation and support of the stand.

It is contemplated that the carriage including the constant force springs and brake arrangement may have other embodiments. For example, a single constant force spring may be used in place of the pair as shown in FIG. 4. Equally, the single or pair of constant force springs may be anchored to the other or upper end 34 of the post 30 rather than to the lower end cover 76 as shown in FIG. 4. It is also contemplated that in place of constant force springs, a gas spring may be used anchored at one end to the carriage and at its other end to, for example, the upper end portion of the post 30.

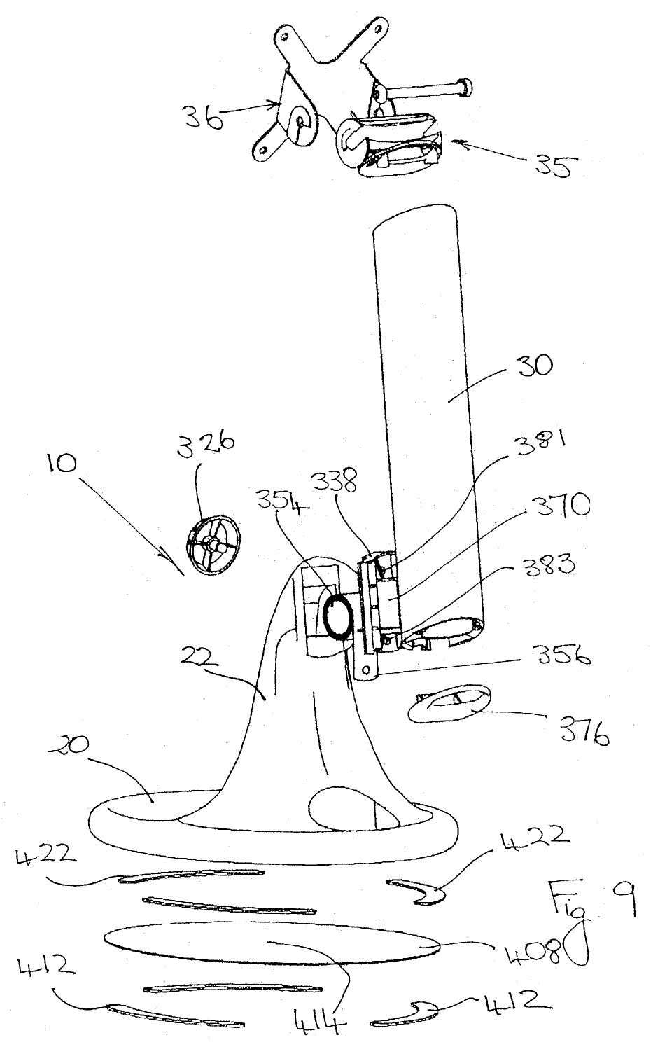

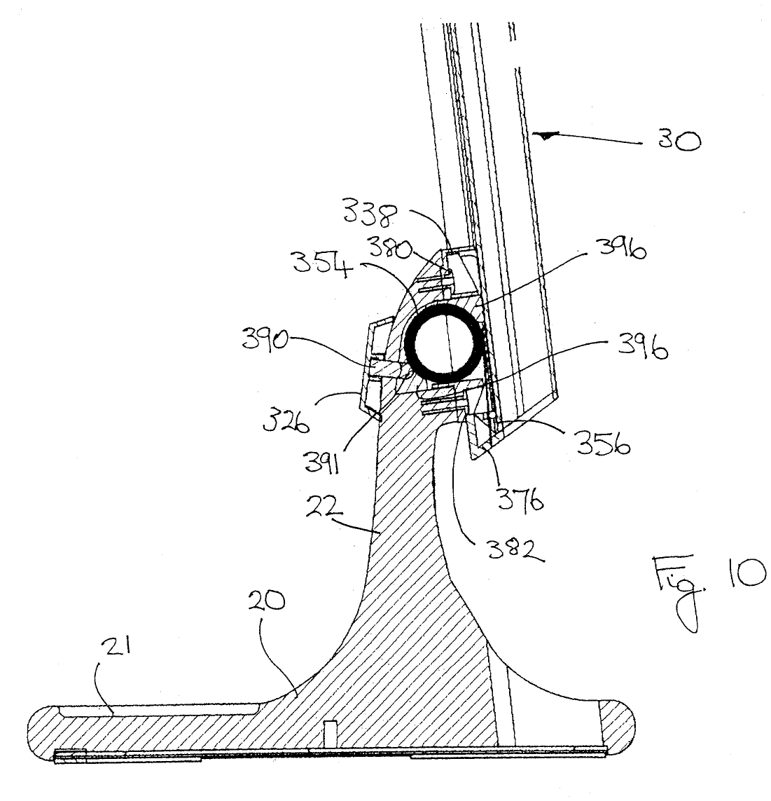

It is further contemplated that the coil of the constant force spring or springs may be located elsewhere than described above, for example, between the carriage 38 and the upstanding portion 22 as shown in FIGS. 9 and 10 and equally, the free end(s) of the single constant force spring or the pair of constant force springs may be anchored to the upper end 34 of the post 30 or to the lower end cover 76 (as shown in FIG. 4 or FIG. 9).

Alternatively in place of the rigid carriage 38 in which the constant force springs 54, 56 are located the carriage may comprise an arrangement as shown in FIG. 6.

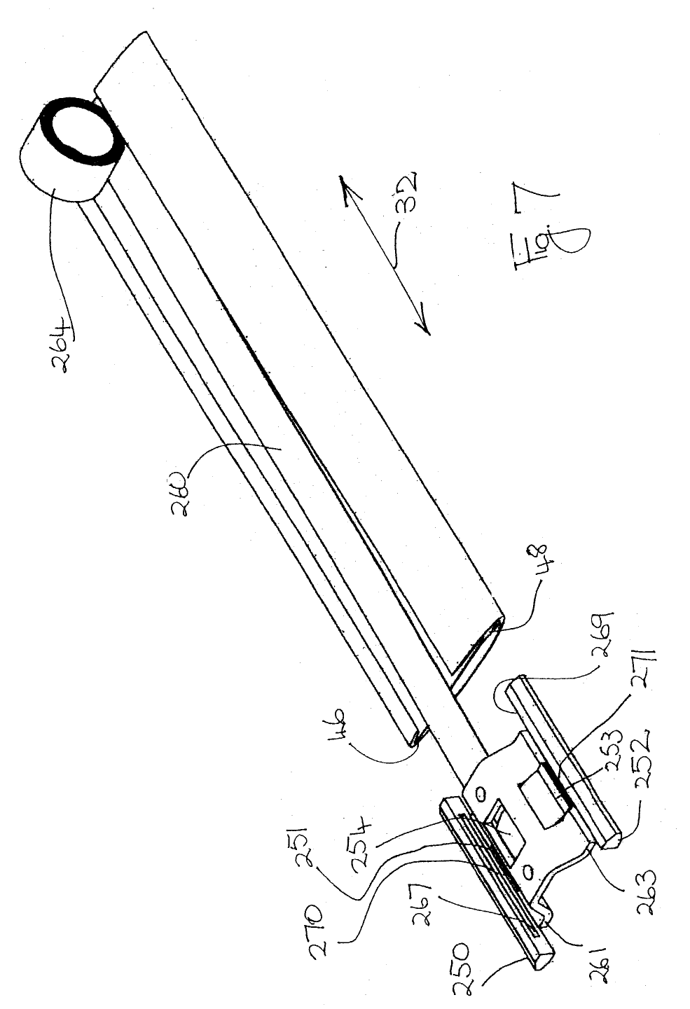

In the embodiment shown in FIG. 6 or FIG. 7, the mechanism 24 is embodied in carriage 238. Carriage 238 is of a substantially U-shaped cross section with the free arms 261, 263 of the U having outwardly directed flanges 264, 265 for being accommodated in slots 267, 269 provided in the runners 250, 252 with the free ends 251, 253 of the leaf spring 254 also accommodated in slots 270, 271 of respective runner 250, 252. Pressing in the direction of arrow 256 forces the leaf spring 254 downward and the runners 250, 252 outwardly, as shown by arrows 255, 257, to frictionally engage within the grooves 46, 48 of the open channel 44. Action in the direction of arrow 256 is achieved by a knob similar to the knob 26 shown in FIG. 5 rotating clockwise, with the knob 26 held in position by reason of the friction between the runners 250, 252 and their associated grooves 46, 48 or otherwise, within the knowledge of a person skilled in the art, for example, the knob may be provided with a stop, a resiliently biased mechanism or other means to hold the knob in either the locked position or the unlocked position of the carriage 238.

When the knob is moved anti-clockwise pressure on the spring 254 is removed withdrawing the runners 250, 252 from their respective grooves 46, 48 allowing the post 30, under manual pressure and the action of the constant force spring(s) 260, to move with respect to the carriage 238 up or down. As seen in FIG. 7, the constant force spring 260 is attached at one end 262 to the carriage 238 and at the other end 264 to the interior of the open channel 44. The carriage 238 is fixed to the upstanding portion 22 by fixtures, as described with respect to FIG. 2, through apertures 266, 268. The spring 260 may also be attached between the carriage 238 and the lower end cover 76 or more than one spring may be used each attached to either or both of the upper and/or lower ends of the post 30. The spring 260 as shown in FIG. 7 is arranged for rotation about an horizontal axis. Equally the spring 260 or a pair of springs, as in FIG. 2, may be arranged on the carriage 238 to rotate about one or a pair of vertical axes. When the desired height has been achieved the knob is rotated clockwise thereby forcing the spring 254 down and outwardly as shown by the arrows 255, 257 in FIG. 6 forcing the runners 250, 252 into their associated grooves 46, 48 and thereby locking the carriage 238 with respect to the post 30.

The grooves 46,48 in addition to having a frictional engagement with the runners 250, 252, may be of complementary shape to the runners 250, 252 whereby there is not only frictional engagement but also mating engagement between these parts.

Referring to FIG. 9 the constant force spring 354 is located between the carriage 338 with the free end 356 thereof attached to the lower end cover 376 as shown more directly in FIG. 10. Spring 354 has the axis of the coil thereof arranged horizontally. The carriage 338 is attached to the upright portion 22 of the stand by fixtures 380, 382 through apertures 381, 383 in the carriage 338. The knob 326 is attached to the upright portion 22 of the stand by axle 390 with the end 391 of the axle 390 bearing directly on mechanism 396 which is shaped to extend towards the post 30 through aperture 370 in the carriage 338 and about the spring 354 so that when the knob 326 is rotated sufficiently clockwise, mechanism 396 contacts the open channel of the post 30 to act as a brake, preventing movement between carriage 338 and post 30. A locking mechanism can be provided for the knob 326 to ensure that the braking action is maintained as required such locking mechanism being within the knowledge of a person skilled in the art. The carriage 338 and post 30 are provided with respective means whereby the post 30 can move relative to the carriage 338 such as described herein.

As shown in FIG. 9 and FIG. 10, the underneath of the base 20 is provided with a singular bearing plate 408 held between two sets of three banana shaped circlips 412, 422 as an alternative mechanism allowing the base portion 20 to be rotatable. The singular bearing plate 408 is held to the underneath of the base portion 20 by a fixture through aperture 414 in a manner as described herein or by a method within the knowledge of a person skilled in the art.

While in the embodiments of FIGS. 1-5 or FIGS. 6, 7 the grooves 46, 48 are part of the open channel 44 and the runners 50, 52 or 250, 252 are part of the carriage 38, 238, it is contemplated that the position of these co-operating components may be interchanged. That is, the grooves 46,48 may be provided as part of the carriage 38, 238 and the runners 50, 52 or 250, 252 may be provided as part of the open channel 44 mutatis mutandis. As for the embodiments of FIGS. 1-5 or FIGS. 6, 7, the grooves 46,48 are of complementary shape to the runners 50, 52 or 250, 252 so that the post 30 can move relative to the carriage 38, 238.

In place of constant force springs, carriage 38, 238 may be moved with respect to the post 30 using a rack and pinion arrangement or an arrangement of elastic cords or bands, for example an elastic cord may provide the required force by being attached to the carriage 38, 238 at one end and extending from there to the bottom end and then to the top end of the post 30 in a continuous path, or some similar arrangement, within the knowledge of a person skilled in the art.

The runners 250, 252 may be made of acetal while the carriage 238, 38 may be made of a sheet steel and the leaf spring 254 of FIG. 8 and the constant force spring(s) 54, 56 may be made of spring steel. The post 30 may be made as an aluminium extrusion or in some embodiments may be made of a plastics material. The support 36 for the flat panel display device may be made of a metallic material such as aluminium which is fixed to the panel display device by fixtures such as screws or bolts or other methods of attachment preferably permitting ready detachment of the panel display device. The base 20 and upstanding portion 22 may be made of a metal or a plastics coated metallic material or of an entirely plastics material within the knowledge of a person skilled in the art.

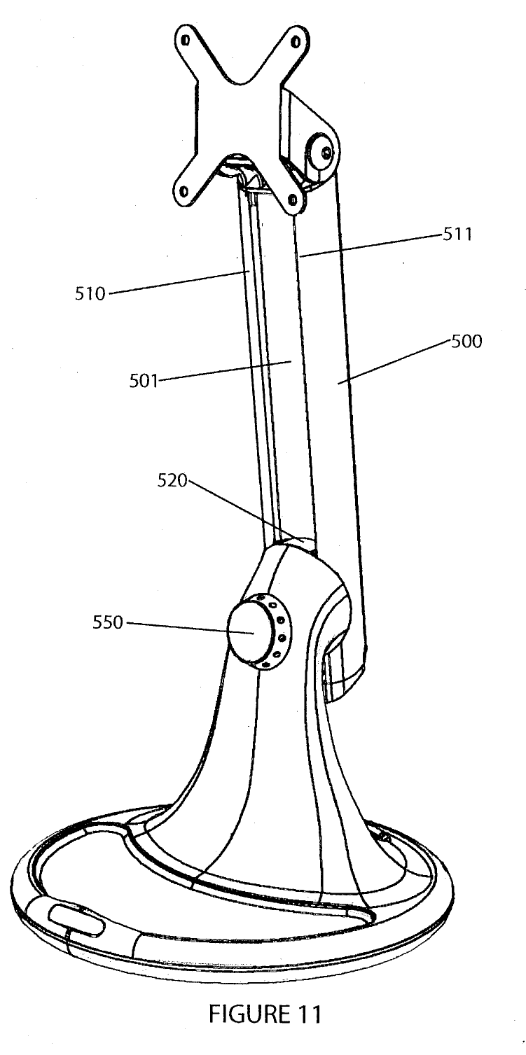

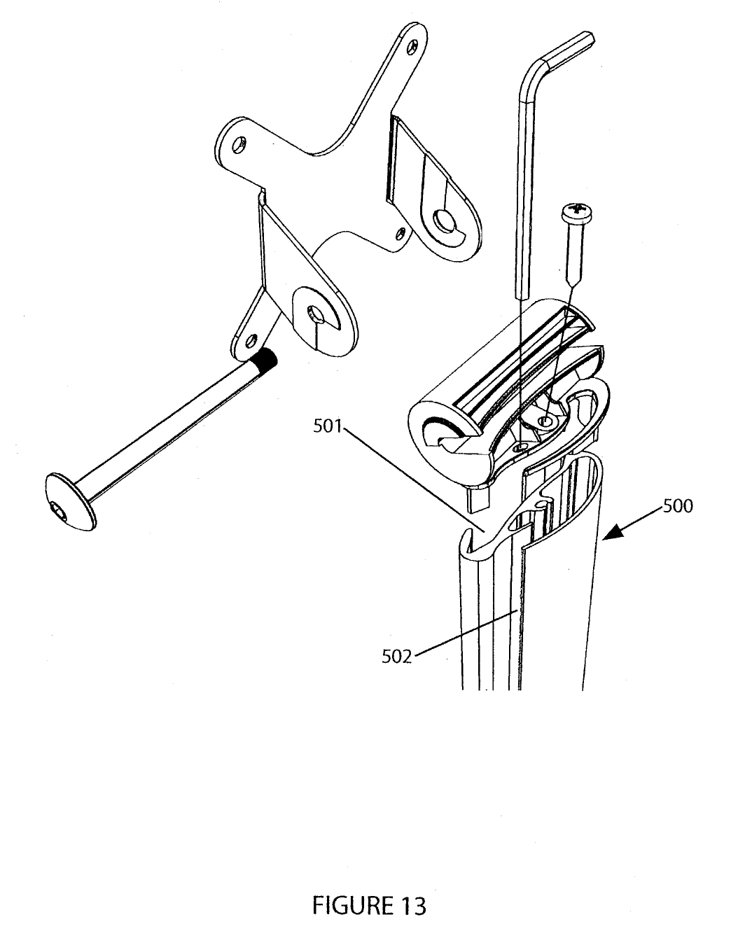

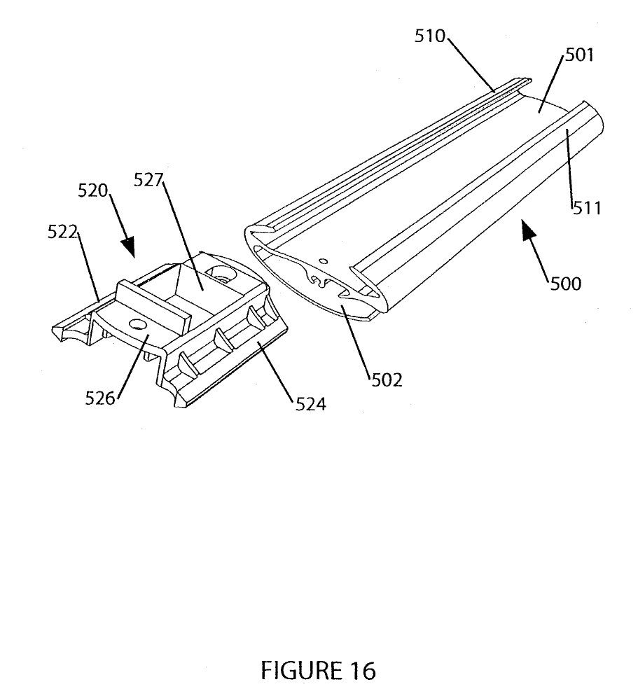

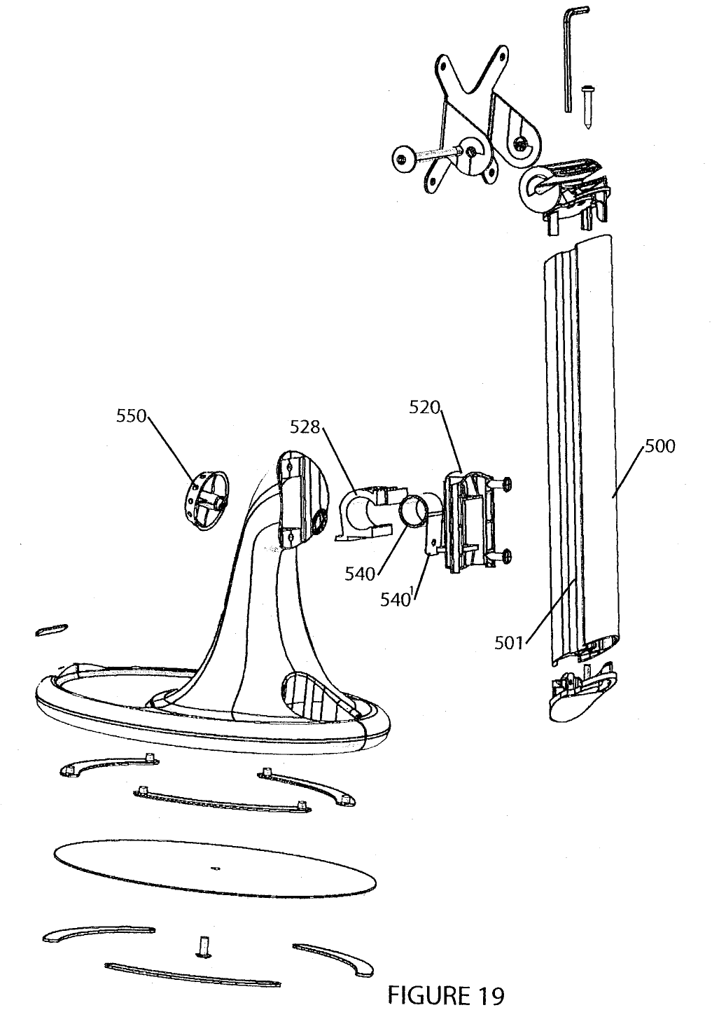

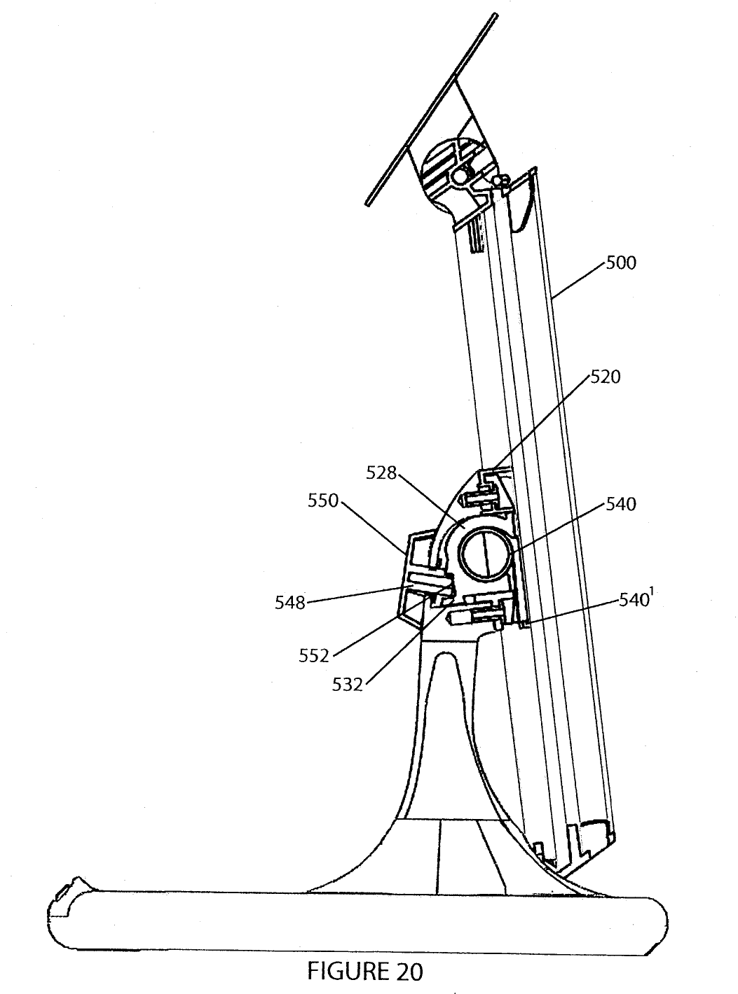

Referring to FIGS. 11-20, a further embodiment of the stand is shown. This embodiment includes an alternative form of the post, carriage, spring, brake and related components.

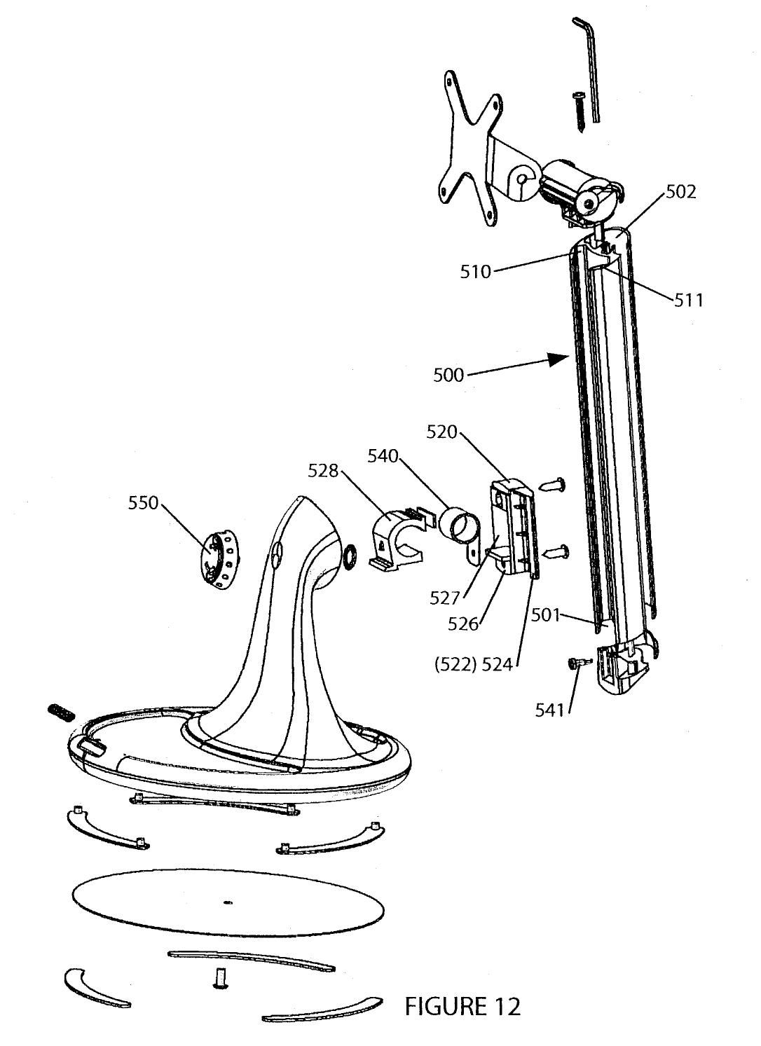

Referring to FIG. 12, an alternative post 500 includes a first open channel 501 provided for guiding the carriage 520 while a second open channel 502 at one side of the post 500 can accommodate power supply and control cables for the flat panel display when the latter is attached to the top 504 of the post 500. The second open channel 502 can provide quick and easy access for the cables while hiding the cables from view providing a more aesthetic appearance and a safer working environment.

As shown in FIG. 12, the post 500, has the first open channel 501 formed by grooved side walls 510, 511 and part of the second open channel 502. The side walls 510, 511 accommodate respectively complementarily shaped runners or fins 522, 524 of the carriage 520.

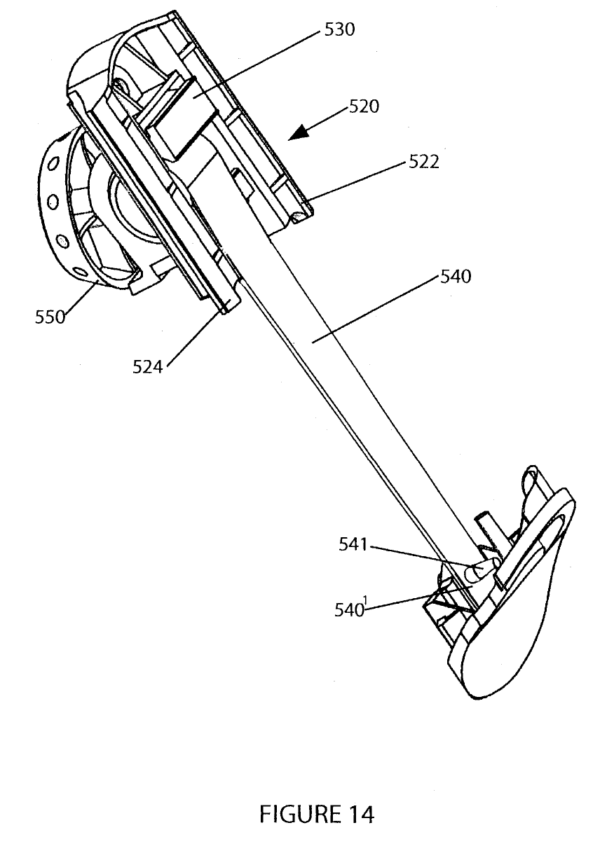

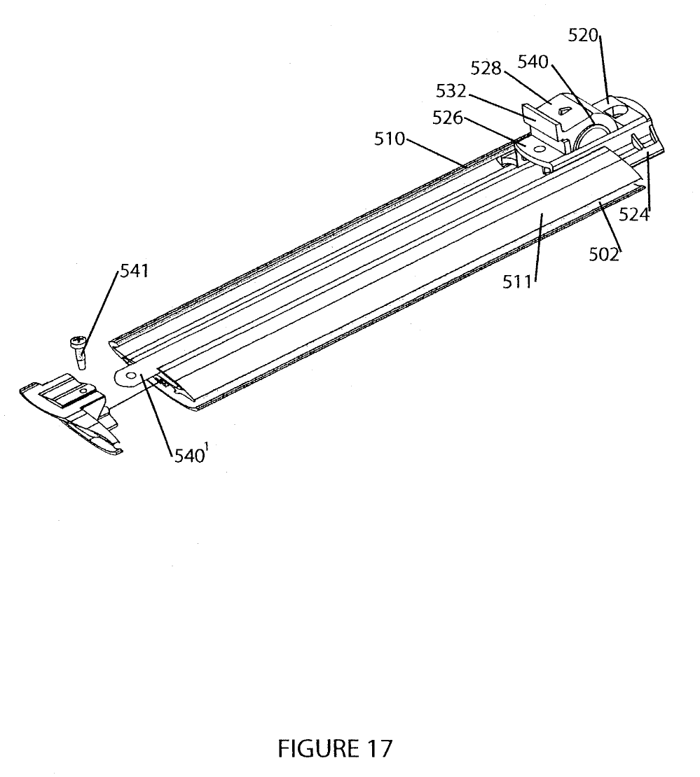

Referring to FIG. 14, the carriage 520 includes a central body 526 and a pair of outwardly projecting runners or fins 522, 524 shaped to fit and freely run in the side walls 510, 511 of the open channel 501 of the post 500. A constant force spring 540 is accommodated within the hollow cavity 527 of the central body 526 of the carriage 520 surrounded by a C-shaped clamp 528. The free end 540′ of the spring 540 is anchored in the lower end cover of the post 500 by a fixture 541 (see FIGS. 14 and 17). The clamp 528 is resilient and clips around the spring 540 with the shoe 530 at one end holding the clamp 528 to the carriage 520. A tongue 532 at the other end of the clamp 528 projects rearwardly into the interior of the upstanding portion where it engages an axial projection 548 of the knob 550.

Rotating knob 550 clockwise presses the inclined end 552 of the axial projection 548 along the curved surface of the clamp 528 towards the tongue 532 which is also constrained thereby, forcing the clamp 528 to close about the spring 540 along the circumference 542 thereof and at the tangential feed-off portion 544. Thus the projection 548 effects a braking action when the interior surfaces of the clamp 528 touch the spring 540, the interior surfaces of the clamp 528 forming a brake shoe 560.

Rotating knob 550 anti-clockwise releases the pressure of the clamp 528 at the tongue 532 and allows the spring 540 to rotate about its axis and the post 500 to move with respect to the carriage 520, such movement being free and balanced with any degree of resistance being dependant on the braking friction applied by the knob 550.

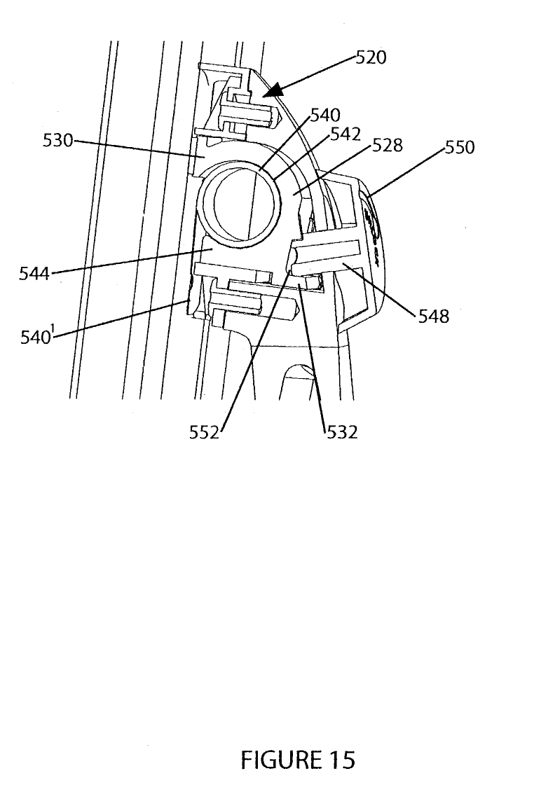

As shown in the assembled version of FIG. 11, the fins 522, 524 of carriage 520 rest in the grooves 510, 511 of the open channel 501 while, as shown in the exploded view of FIG. 12, or the side vie of FIG. 15, the pins 580, 582 hold the carriage 520 to the upstanding portion.

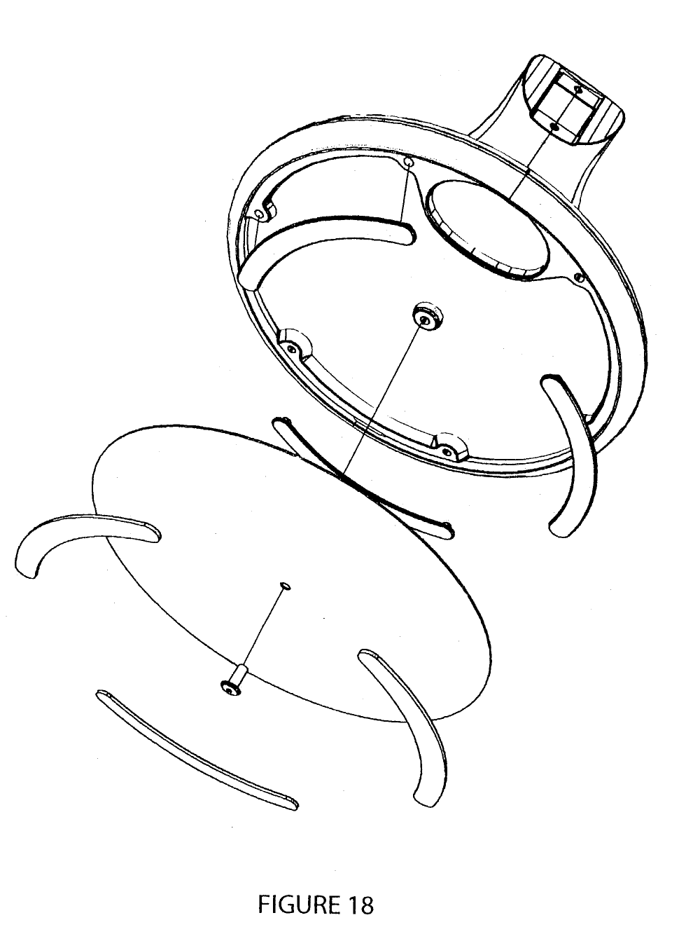

Other features of the stand of the embodiment of FIGS. 11-20 can be as shown in FIGS. 1-10, for example, FIG. 18 is an underneath view of the embodiment of the base as shown in FIG. 9.

Although the invention has been described above with respect to preferred embodiments thereof variations therein are contemplated within the knowledge of a person skilled in the art.

1. A stand including a base for supporting said stand in an upright position on a substantially horizontal support surface; upstanding means extending upwardly from said base and stationary with respect thereto for supporting upwardly extending post means at a position elevated above said base; said post means being continuously movable with respect to said upstanding means from a first position to a second position; means for releasably securing said post means at a position from said first to said second position; attachment means for removably attaching a flat panel display device to an end of said post means.

2. A stand as claimed in claim 1, wherein said base is rotatable with respect to said support surface.

3. A stand as claimed in claim 2, wherein said base is rotatable through up to 360° while said post means can be moved up to approximately 130 mm with respect to said upstanding means.

4. A stand as claimed in claim 3, wherein said attachment means is located at an upper end of said post means and is rotatable with respect to an axis orthogonal with respect to the longitudinal axis of said post means through approximately 90°.

5. A stand as claimed in claim 4, wherein said attachment means has two orientations allowing a height adjustment of approximately 20 mm. in addition to the height adjustment provided by movement of said post means.

6. A stand as claimed in claim 5, wherein said longitudinal axis of said post means is inclined forwardly approximately 7° with respect to the normal to the plane of the base, whereby the centre of gravity of the stand, with or without a flat panel display device attached, is located through the central area of said base of the stand to provide stability thereof irrespective of the position of the post means with respect to the upstanding means.

7. A stand as claimed in claim 2, wherein said post means includes a first channel means and a second channel means.

8. A stand as claimed in claim 7, wherein said first channel means provides a conduit for electrical leads to power said flat panel display device and said second channel means provides a guide path for a mechanism by which said post means may be moved with respect to said upstanding means and thereby adjusted in height with respect to said base.

9. A stand as claimed in claim 8, wherein said second channel means includes an open channel.

10. A stand as claimed in claim 8, wherein said first channel means includes an open channel.

11. A stand as claimed in claim 8, wherein said first channel means includes a closed channel.

12. A stand as claimed in claim 8, wherein said second channel means includes an open channel and said mechanism includes a carriage which may be releasably engaged with said second channel means whereby in a released condition said channel can move with respect to said carriage and in an engaged condition said second channel means is engaged frictionally with said carriage thereby preventing movement of said second channel means with respect to said carriage.

13. A stand as claimed in claim 12, wherein said carriage means includes resilient means biasing said post means along said longitudinal axis.

14. A stand as claimed in claim 8, wherein said second channel means includes an open channel and said mechanism includes a carriage which may be releasably engaged by brake means whereby in a released condition of said brake means said second channel means can move with respect to said carriage and in an engaged condition of said brake means said second channel means is prevented from moving with respect to said carriage.

15. A stand as claimed in claim 14, wherein said carriage means further includes resilient means biasing said post means along said longitudinal axis.

16. A stand as claimed in claim 15, wherein said brake means releasably restrains movement of said post means along said longitudinal axis by frictional engagement with said resilient means.

17. A stand as claimed in claim 16, wherein said resilient means includes at least one constant force spring fixed at one point to at least one end of said post means.

18. A stand as claimed in claim 16, wherein said resilient means includes two constant force springs.

19. A stand as claimed in claim 17, wherein said resilient means is fixed at one point to a lower end of said post means.

20. A stand as claimed in claim 17, wherein said resilient means is fixed at one point to an upper end of said post means.

21. A stand as claimed in claim 18, wherein said resilient means are attached to either end of said post means.
